(19) United States
(12) Patent Application Publication
(10) Pub. No.: US 2003/0046060 A1
(43) Pub. Date: Mar. 6, 2003

(54) Rule-based document composing

(76) Inventor: Juergen Roeck, San Francisco, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/000,111

(22) Filed: Oct. 31, 2001

Related U.S. Application Data
(60) Provisional application No. 60/317,361, filed on Sep. 4, 2001.

(51) Int. Cl. G06F 17/27

(52) U.S. Cl. 704/9

(57) ABSTRACT

A method and apparatus is described herein for providing for receiving a list of required elements, providing for adding elements from the list to a communication until an end of the list is reached, providing for parsing and modifying the elements according to a natural language rule and limitation set, wherein parsing and modifying includes modifying transitional zones and fusing the elements into a cohesive composite communication, and providing for dispatching the communication to media channels.

The present application claims priority to the provisional filed application entitled Rule-Based Document Composing, filed on Sep. 4, 2001, serial No. 60/317,361, also incorporated herein by reference.

### FIELD OF THE INVENTION

This invention relates generally to the field of information systems, and more specifically to the field of natural language processing.

### BACKGROUND OF THE INVENTION

In large organizations with multipl products and processes, it is very often a practice to combine several predefined information blocks into one communication that responds and/or refers to multiple inputs. However, the resulting assembled composite communication may be awkward and lack cohesion if each information block is not linked smoothly to the block that precedes and/or follows it, and if certain cross references between blocks and other, similar modifications of information blocks are omitted.

### SUMMARY OF THE INVENTION

A method and apparatus is disclosed that allows the assembly of a unified, cohesive communication from multiple predefined information blocks, in such a way that references between blocks, transitions in natural language at the end and at the beginning of each block, and other similar modifications are generated, so the resulting communication is cohesive and sensible to a person receiving it, independent of the medium.

### BRIEF DESCRIPTION OF THE DRAWINGS

FIG. 1 is a schematic diagram showing an overview of the software architecture of a preferred embodiment; and

FIG. 2 is a flow diagram of a method for rule-based document composing according to one embodiment.

### DETAILED DESCRIPTION OF THE INVENTION

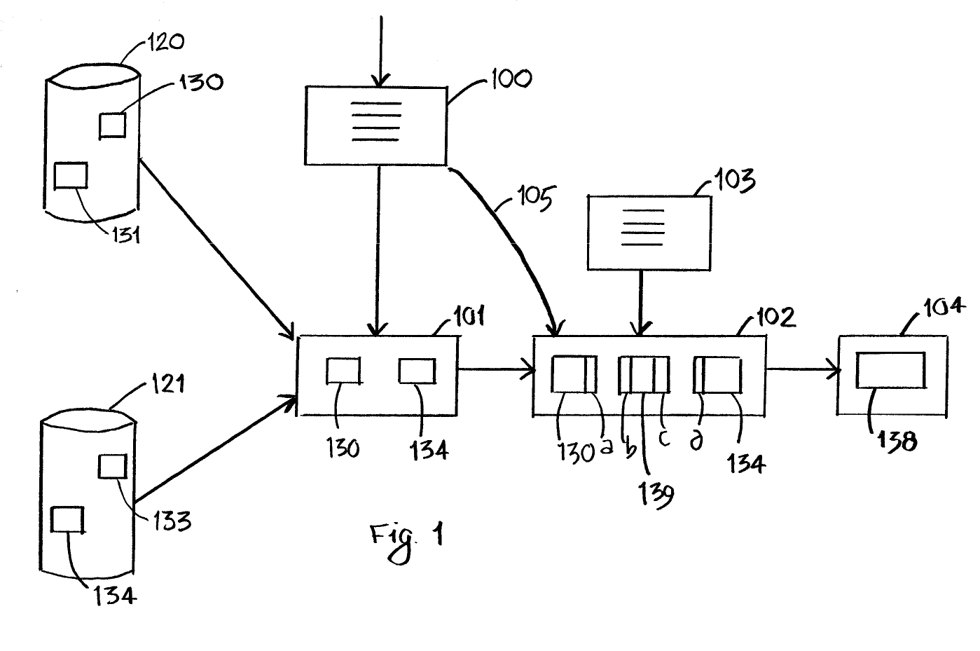

FIG. 1 is a schematic diagram showing an overview of the software architecture of one embodiment. The list 100 of information blocks required to comprise the communication is received from the outside of this process, e.g. from an application (not shown), such as a workflow system, or other types of applications including an embodiment with human interaction or receiving communications, all of which is creating communications that are processed. Elements from two databases 120 and 121 are glued together by a composer 101, according to the requirements of list 100. In one embodiment, the composer 101 processes elements 130 and 134, which are the information blocks listed in list 100, out of the databases 120 and 121, respectively.

It is clear that there may be many variations and embodiments of the invention, such as having only a single database (in one embodiment supplying multiple elements), having multiple databases, or having some (one or more, not shown) non-database repository from which information blocks may be retrieved. Also, in one embodiment, the retrieved information blocks may be any combination of a variety of multimedia information types, such as text, email, HTML, graphic images, video, audio, etc.

Once the resulting message is composed, it is processed by natural language processor 102, which uses natural language rule and limitation set 103. Also, in one embodiment, processor 102 may access the original list 100 provided by link 105.

For example, information blocks 130, 134, and 139 shown in FIG. 1 according to one embodiment have beginning and ending zones a, b, c, and d. These transitional zones are modified to fuse the information blocks into a cohesive composite communication 13x, which is visible in mailer or responder 104. Mailer or responder 104, upon receiving communication 13x, then decides how to dispatch it.

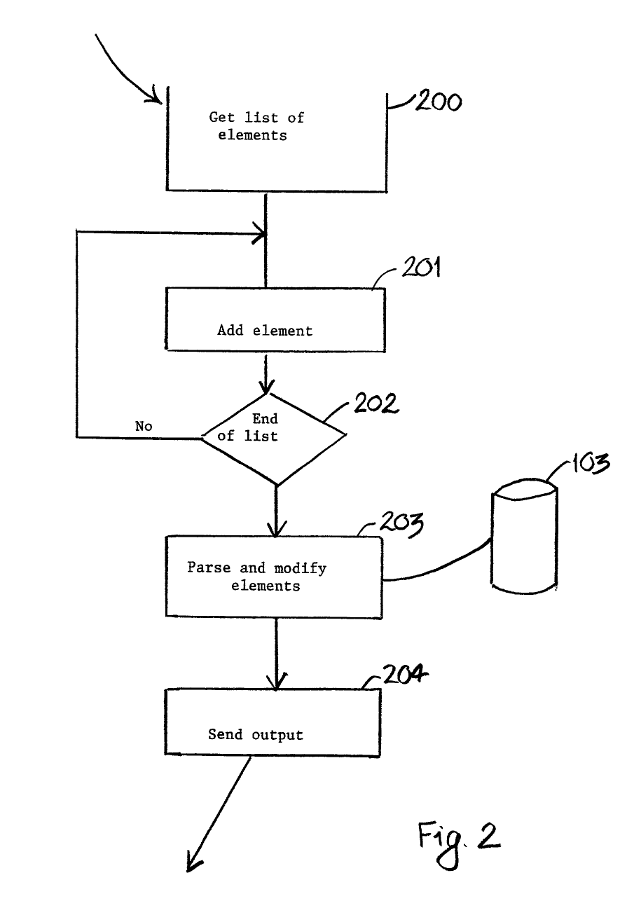

FIG. 2 is a flow diagram of a method for rule-based document composing according to one embodiment. In process block 200, the list of required elements is received. In process block 201, elements from the list are added to a communication until, in process block 202, the end of the list is reached. Then, in process block 203, the elements are parsed and modified according to the natural language rule and limitation set 103. In one embodiment, additional templates and, as mentioned earlier, input from the original list via link 105 may be used as well. The modified output now represents a homogenous communication, which, in process block 204, is dispatched to appropriate media channels.

One embodiment may be particularly applicable to situations where communications contain directives (actions items) for multiple actions, and each different action directive is derived from a separate information block. The separately generated and maintained information blocks are pulled together and processed, to result in one comprehensive communication. More particularly, for example, in one embodiment an email may contain two or three different action items that have been generated and maintained by different elements in a system, in, for example, a complex enterprise customer service center, using for example workflow software to process separate pieces, which then are pulled together again.

Besides containing standard elements, in one embodiment list 100 may also contain text or content blocks that are embedded into responder or mailer 104. For example, element 139, mentioned earlier in block 102, may be a text or content block that is itself a list item in list 100 rather than a link to some information block repository, because it is an action item result. In another embodiment, even action item results may be stored in repositories by their respective generators, and may then be drawn out by the composer.

An application of one embodiment could be, for example, automatic generation of an instruction manual (i.e. the communicated content) for a software system that is generated from various different, discrete software blocks. As the blocks are combined in a script or descriptive language, such as list 100, for example, their corresponding instructive information blocks are drawn from databases describing how to make each software block function. To produce a cohesive manual, language of those blocks may need adaptation in the beginning and ending zones, as shown in FIG. 1 (zones a, b, c, d), as well as, in some cases, in cross-references between elements (not shown).

The processes and embodiments as described above can be stored on a machine-readable medium as instructions. The machine-readable medium includes any mechanism that provides (i.e., stores and/or transmits) information in a form readable by a machine (e.g., a computer). For example, a machine-readable medium includes read only memory (ROM); random access memory (RAM); magnetic disk storage media; optical storage media; flash memory devices; electrical, optical, acoustical or other form of propagated signals (e.g., carrier waves, infrared signals, digital signals, etc.). The device or machine-readable medium may include a solid state memory device and/or a rotating magnetic or optical disk. The device or machine-readable medium may be distributed when partitions of instructions have been separated into different machines, such as across an interconnection of computers.

It is clear that the various embodiments described herein could be used to allow cross-referencing between blocks, even when the cross-references are not fixed at the time of creation of the blocks. While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A method comprising:
providing for receiving a list of required elements;
providing for adding elements from the list to a communication until an end of the list is reached;
providing for parsing and modifying the elements according to a natural language rule and limitation set, wherein parsing and modifying includes modifying transitional zones and fusing the elements into a cohesive composite communication; and
providing for dispatching the communication to media channels.

2. The method of claim 1, wherein parsing and modifying includes using input from the list.

3. The method of claim 1, wherein the list includes content that is embedded into a responder or mailer.

4. The method of claim 1, wherein the elements include an action item result in the list.

5. The method of claim 1, wherein the elements include information blocks.

6. The method of claim 5, wherein the information blocks are retrieved from at least one database or repository.

7. The method of claim 5, wherein the information blocks include text, email, HTML, graphics images, video, and audio.

8. A machine-readable medium that provides instructions that, when executed by a machine, cause the machine to perform operations comprising:
providing for receiving a list of required elements;
providing for adding elements from the list to a communication until an end of the list is reached;
providing for parsing and modifying the elements according to a natural language rule and limitation set, wherein parsing and modifying includes modifying transitional zones and fusing the elements into a cohesive composite communication; and
providing for dispatching the communication to media channels.

9. The machine-readable medium of claim 8, wherein parsing and modifying includes using input from the list.

10. The machine-readable medium of claim 8, wherein the list includes content that is embedded into a responder or mailer.

11. The machine-readable medium of claim 8, wherein the elements include an action item result in the list.

12. The machine-readable medium of claim 8, wherein the elements include information blocks.

13. The machine-readable medium of claim 12, wherein the information blocks are retrieved from at least one database or repository.

14. The machine-readable medium of claim 12, wherein the information blocks include text, email, HTML, graphics images, video, and audio.

15. An apparatus comprising:
a composer to receive a list of required elements and add elements from the list to a communication until an end of the list is reached;
a natural language processor coupled with the composer, the natural language processor to parse and modify the elements according to a natural language rule and limitation set, and thereby to modify transitional zones and fuse the elements into a cohesive composite communication; and
a mailer or responder coupled with the natural language processor, the mailer or responder to dispatch the communication to media channels.

16. The apparatus of claim 15, wherein the natural language processor is to use input from the list in order to parse and modify.

17. The apparatus of claim 15, wherein the list includes content that is embedded into the responder or mailer.

18. The apparatus of claim 15, wherein the elements include an action item result in the list.

19. The apparatus of claim 15, wherein the elements include information blocks.

20. The apparatus of claim 19, further comprising at least one database or repository coupled with the natural language processor to provide for retrieval of information blocks.

21. The apparatus of claim 19, wherein the information blocks include text, email, HTML, graphics images, video, and audio.
